(19) United States
(12) Patent Application Publication
(10) Pub. No.: US 2025/0369414 A1
(43) Pub. Date: Dec. 4, 2025

(54) REGENERATIVE ENERGY SYSTEM USING KINETIC ENERGY TRANSFER FROM WAVE MOTION AND TRAIN MOTION TO A GENERATOR

(71) Applicant: G.R.E.S. LLC, Sun Valley, CA (US)

(72) Inventor: Ashot Salvaryan, Sun Valley, CA (US)

(21) Appl. No.: 19/227,345

(22) Filed: Jun. 3, 2025

Related U.S. Application Data
(60) Provisional application No. 63/655,501, filed on Jun. 3, 2024.

(51) Int. Cl. F03B 13/14; H02K 7/06; H02K 7/116; H02K 7/18

(52) U.S. Cl. CPC F03B 13/14; H02K 7/06; H02K 7/116; H02K 7/1853

(57) ABSTRACT

The present invention is a system and method for providing a regenerative energy system and method for capturing kinetic energy from wave motion or the relative motion of train cars on tracks to generate electricity, wherein the system uses a hydraulic mechanism coupled to a wave motion capture system or train track components to convert vertical movement into rotational motion, wherein this rotational motion is amplified by a gear reduction assembly, driving one or more generators to produce electrical power. The generated electricity can be utilized in real time by electrical motors, stored in batteries or supercapacitors, or supplied directly to the power grid, wherein the invention integrates hydraulic conversion, motion amplification, and efficient energy transformation to create a durable, scalable system for renewable energy production, and wherein it is designed to harness repetitive, continuous movements, making it applicable for sustainable energy in coastal and transportation infrastructures.

### BACKGROUND

### Field of the Invention

This invention relates generally to power regeneration systems. More specifically, the invention pertains to a system and method for reclaiming kinetic energy that is generated by the movement of an object. Previous iterations of the invention have concentrated on capturing kinetic energy from the vibrations that are experienced by a vehicle suspension system. This invention is more specifically directed to capturing energy from the motion of water or the motion of a train. First, the vertical motion from a wave or a train is converted to a rotational motion, then the rotational motion may be directed to a generator to produce electricity.

### Description of Related Art

The prior art includes various examples of kinetic energy recovery systems that are specifically designed as components of a vehicle, and which are capable of generating electrical energy that may also be used by a vehicle.

One example of the prior art teaches a piston type of pump that is mounted between a vehicle frame and the suspension. The pump charges a high-pressure accumulator for driving hydraulic motors, e.g., power windows, power seats, alternator, etc.

In another embodiment, electricity is generated directly by a conductor moving with respect to a magnetic field as a result of the up and down motions of a vehicle suspension system.

In another invention, an air compressor mounted between the vehicle frame and suspension compresses air for storage in a pressure tank and is used to power pneumatic devices.

Still another document in the prior art teaches an energy regeneration device that is disposed within a chassis spring of a suspension system that transforms kinetic energy generated by elongation and compression of the chassis spring to electrical energy by the piezo electrical effect. A suspension device of a vehicle is provided with one or more links for connecting to a vehicle body which is supported using a chassis spring and a shock absorber, and it may modulate movement of a vehicle body and a wheel by modulating rigidity and flexibility.

The system described above includes a transforming body configured to be compressed or elongated by a chassis spring of the suspension system, and an electric generating member that is electrically connected and configured to be compressed or elongated with the transforming body.

The transforming body is disposed between coils of the chassis spring of the Suspension system. The electric generating members are aligned between adjacent pitches of the coils so that the electric generating members are compressed or elongated by relative movements of the coils.

The energy generation system also includes a rectifier that is electrically connected with the electric generating members through the connector and rectifies an electric current made by the electric generating members, where the electric generating member is a piezoelectric element.

What is apparent from the prior art is that there seem to be many different ways of capturing the kinetic energy of movement and transforming it into usable mechanical and/or electrical energy.

However, the prior art appears to suffer from various drawbacks including, but not limited to, not generating a significant amount of energy, not generating energy rapidly, and being too fragile to work consistently in the environment in which they operate because of operating conditions.

Accordingly, it would be an advantage over the prior art to provide a durable method of converting mechanical or kinetic energy into electrical energy in sufficiently large quantities to make the capturing of the kinetic energy economically viable. It would be a further advantage to create a two-step process, wherein a first step is to hydraulically convert linear motion to rotational motion, and a second step is to more efficiently convert the rotational motion to electrical energy.

It is useful to examine a previous version of the present invention in more detail to observe how it has been improved.

FIG. 1 is a block diagram of the components of a prior art version of the invention. As will be explained, the prior art is able to capture the kinetic energy from both the upward and the downward motion of a vehicle suspension system 8.

In the block diagram view in FIG. 1, a rack and pinion assembly 10 may be coupled to the vehicle suspension system 8. The rack and pinion assembly 10 is then coupled to a linear motion to rotational movement conversion system 12 which is in turn coupled to a rotational movement amplification system 14. The rotational movement amplification system 14 is then coupled to an alternator or generator 16 for generating electricity. The combination of the rack and pinion assembly 10, the linear to rotational movement conversion system 12, the rotational movement amplification system 14, and the alternator 16 may be referred to as the regenerative energy system 18.

FIG. 2 is a perspective view of the prior art of the present invention. FIG. 2 shows only a portion of a vehicle so that the elements of the prior art are more easily visible. What is shown is the vehicle chassis or frame 20 that provides support for the wheels 22, the vehicle suspension system 24, and a passenger compartment (not shown) that rests upon the vehicle suspension system. In the case of an electric vehicle, the vehicle will also have one or more electric motors (not shown) and a battery (not shown) and may also include a supercapacitor (not shown).

While a relatively small frame 20 is shown for the vehicle, this is for illustration purposes only. Accordingly, the frame 20 may be lengthened or shortened and disposed in larger or smaller vehicles. Thus, any vehicle having a vehicle suspension system or is a vehicle that is caused to move up-and-down as it travels may utilize the prior art of the invention. The vehicles that may utilize the prior art of the invention may include, but should not be considered as limited to, a compact car, a mid-size car, a large sedan, a cross-over vehicle, a sport utility vehicle, a pickup truck, a van, a bus, a utility vehicle, a truck, and a semi-truck. This list should be considered only as a sample of the vehicles that may utilize the prior art of the present invention and not a limiting factor.

While the frame 20, the wheels 22, and the vehicle suspension system 24 of the vehicle are shown in FIG. 2, also displayed are components of the prior art of the invention. These elements include a plurality of rack and pinion systems, each comprised of a plurality of rack and pinion gear boxes 26 and linear transformation racks 28 (or linear transformation system). The prior art is also comprised of a gear reduction system 30, and a double shaft alternator or generator 32 (only referred to as an “generator” hereinafter).

Subsequent drawings will illustrate the features of the prior art in greater detail; however, it is noted that the double shaft generator 32 is being rotated by gear reduction systems 30 on both sides, hence the need for the double shaft on the alternator. Thus, a gear reduction system 30 is disposed on each side of the double shaft generator 32 to ideally keep the alternator rotating in an uninterrupted manner whenever the vehicle is moving.

Alternatively, the generator 32 may include a single shaft and may be coupled to only one gear reduction system 30.

Accordingly, the design of the prior art is to create uninterrupted rotation of the double shaft of the generator 32 whenever the vehicle is traveling fast enough to cause up and down movement of the vehicle on the road. Uninterrupted rotation is desired because the shaft of the generator 32 needs to be turning in order to generate electricity. A typical alternator in a gas engine can generate electricity when the engine is idling and will rotate at around 800 rpm but will regularly rotate at 2400 rpm or higher. However, the generator 32 may rotate are far slower rpms to generate electricity. For example, electricity may be generated by the generator 32 with as little as 300 rpms.

However, it should also be understood that the generator 32 may periodically slow down or even stop when the vehicle is not moving fast enough to provide the needed movement of the vehicle suspension system.

The prior art may use an induction motor/generator. Alternatively, a second embodiment of the invention may use a motor having a permanent magnet. It is noted that the generators 32 of the embodiments of the invention may generate electricity when rotating as little as 300 rpm.

The prior art is designed with a reduction gear system 30 on each side of the generator 32 so that when the vehicle is traveling above 5 miles per hour, the double shaft of the generator 32 will rotate at a minimum of 1000 rpm.

It should be understood that these figures for rotation of the double shaft of the generator 32 are examples only, and that the shaft may rotate at lower or higher rpms and the generator 32 may still generate electricity to charge a battery or supercapacitor.

It is noted that either a generator or an alternator may be used in the prior art of the invention. Each device has its advantages and disadvantages, and the device is selected that is best suited to the application. For example, while both generators and alternators convert mechanical energy into electrical energy, alternator brushes generally last longer than those of generators, and alternators can fit into smaller spaces than generators. In addition, while alternators only generate AC voltage, a generator can produce both AC and DC voltage. A single vehicle may include both alternators and generators, only alternators, or only generators depending on the operational needs of the vehicle.

The prior art shown in FIG. 2 shows a rack and pinion gear box 26 at each corner of the frame 20. Using more than one rack and pinion gear box 26 in the vehicle enables more torque to be generated to thereby turn more than one generator 32 to generate electricity in the prior art. Thus, while the prior art shows a single generator 32, a plurality of generators 32 may be disposed in a single vehicle.

It is likely that a plurality of generators 32 operating in series may be used in a single vehicle in order to generate a typical 480 volts of an electric vehicle battery. For example, the generator of the prior art may be capable of generating 48 volts and thus an increase in voltage is clearly necessary. This may be accomplished by a combination of adding generators and electronically increasing the voltage. Thus, there are devices or circuits such as voltage regulators and transformers that enable a smaller voltage to be increased to a greater voltage sufficient for charging a battery or a supercapacitor, as is known to those skilled in the art.

The output of the generator 32 may also be discussed in terms of watts. A typical generator 32 may generate 1000 to 2500 watts. Therefore, two generators 32 operating in series may thus typically generate anywhere from 2 to 5 kW. However, these numbers should be considered only as examples and that selection of specific generators 32 may vary these results.

A last feature of the prior art shown in FIG. 2 is the point of contact between the rack and pinion gear box 26 and the frame 20 of the vehicle. Each of the rack and pinion gear boxes 26 includes a vertical rack gear bar 34 that may be in contact with a suspension plate 36 that is coupled to the suspension system 24. The movement of the suspension plate 36 causes the up-and-down movement of the vertical rack gear bar 34 of the rack and pinion gear box 26.

FIG. 3 is a perspective view of the prior art shown in FIG. 2 but without the wheels 22. This figure more clearly illustrates the suspension plate 36 that is contact with the vertical rack gear bar 34 of the rack and pinion gear box 26.

FIG. 4A is a profile view of the frame 20 of the vehicle. The figure also illustrates the wheels 22, the suspension systems 24, the gear and pinion boxes 26, the linear transformation racks 28, the vertical rack gear bars 34, and the suspension plates 36.

While a connection between the linear transformation racks 28 and the vertical rack gear bars 34 is shown as being the suspension plate 36, it is noted that any mechanical system that transfers movements of the suspension system 24 to the gear and pinion boxes 26 may be used and should be considered to be within the scope of the prior art.

FIG. 4B is a bottom view of the frame 20 of the vehicle. The figure also illustrates the tires 22, the linear transformation racks 28, the suspension plates 36, and a support plate 38 for the reduction gear system 30 (not shown) and the generator 32 (not shown) that are disposed on the other side.

FIG. 4B illustrates the relationship between the suspension plates 36 and the vertical rack gear bars 34. It is now useful to examine the details inside the rack and pinion boxes 26 from which the vertical rack gear bars 34 are extended.

FIG. 5 is a perspective view of the inside of the rack and pinion box 26. The rack and pinion box 26 converts the vertical up-and-down motion of the vehicle suspension system 24 to a back-and-forth horizontal motion. The vertical rack gear bar 34 includes a portion with gear teeth that make contact with (engage) a small pinion gear 40. The vertical motion of the vertical rack gear bar 34 causes the small pinion gear 40 to rotate in relatively small increments back and forth. A large pinion gear 42 is directly coupled to the small pinion gear 40.

It should be understood that while the rack and pinion box 26 of the prior art shows the small pinion gear 40 and the large pinion gear 42, more gears could be provided to further amplify the movements of the vertical rack gear bar 34, and thus the utilization of the two gears 40, 42 should not be considered a limiting factor.

The larger diameter of the large pinion gear 42 magnifies the small movements of the small pinion gear 40. The large pinion gear 42 in turn engages the teeth of a top horizontal rack gear bar 44 and a bottom horizontal rack gear bar 46. The top horizontal rack gear bar 44 and the bottom horizontal rack gear bar 46 are thus caused to move back and forth in the direction of the arrows at the end of each horizontal rack gear bar 44, 46.

The greater diameter of the large pinion gear 42 is part of the overall system objective to magnify the small up-and-down vertical movements of the vehicle suspension system 24. The gear ratio between the large pinion gear 42 and the small pinion gear 40 may be modified as needed to achieve the desired rotation of the double shaft of the generator 32. In this illustration, the gear ratio is 1:2.5. If a third gear were added, the gear ratio may increase to 1:6.25, and so on.

After the rack and pinion box 26 has converted the vertical movements of the suspension system 24 to horizontal movements of the top horizontal rack gear bar 44 and the bottom horizontal rack gear bar 46, the next step is performed by the linear transformation rack 28. As shown in FIGS. 2 and 3, the rack and pinion gear box 26 is coupled to the linear transformation rack 28 by a top and a bottom rack gear bar 44, 46. More specifically, a coupling bar 98 is disposed between the top horizontal rack gear bar 44 and the bottom horizontal rack gear bar 46 of each of the rack and pinion gear boxes 26 and the top and bottom horizontal rack gear bars 44, 46 of the linear transformation rack 28.

### BRIEF SUMMARY

The present invention is a system and method for providing a regenerative energy system and method for capturing kinetic energy from wave motion or the relative motion of train cars on tracks to generate electricity, wherein the system uses a hydraulic mechanism coupled to a wave motion capture system or train track components to convert vertical movement into rotational motion, wherein this rotational motion is amplified by a gear reduction assembly, driving one or more generators to produce electrical power. The generated electricity can be utilized in real time by electrical motors, stored in batteries or supercapacitors, or supplied directly to the power grid, wherein the invention integrates hydraulic conversion, motion amplification, and efficient energy transformation to create a durable, scalable system for renewable energy production, and wherein it is designed to harness repetitive, continuous movements, making it applicable for sustainable energy in coastal and transportation infrastructures.

In a first aspect of the invention, it is an object of the present invention to provide a method and system of recovering the kinetic energy associated with the movement of waves to generate electrical energy that may be applied directly to an electrical motor, stored for later use, or transferred to a power grid.

In a second aspect of the invention, it is an object of the present invention to provide a method and system of recovering the kinetic energy associated with the movement of train cars relative to a train track to generate electrical energy that may be applied directly to an electrical motor, stored for later use, or transferred to a power grid.

In a third aspect of the invention, a plurality of hydraulic lines is coupled to vertical movement actuators.

In a fourth aspect of the invention, the plurality of hydraulic lines is used to push hydraulic fluid to thereby cause a back-and-forth linear motion of at least one piston.

In a fifth aspect of the invention, linear motion of the piston is coupled to a system of gears to mechanically convert linear motion to rotational motion.

In a sixth aspect of the invention, the rotational motion may be directed to a generator or an alternator to thereby enable rotational motion to generate electrical energy that may be used at that moment, stored for future use, transferred away for use elsewhere, or all three.

In a seventh aspect of the invention, the small up-and-down movements of the waves or the train cars are amplified through a hydraulic system coupled to one or more gears in order to convert relatively small movements into the turning of gears that directly rotate a shaft of an alternator or generator.

These and other embodiments of the present invention will become apparent to those skilled in the art from a consideration of the following detailed description taken in combination with the accompanying drawings.

### BRIEF DESCRIPTION OF THE SEVERAL VIEWS OF THE DRAWINGS

FIG. 1 is a block diagram of the components of the previous embodiments of the invention.

FIG. 2 is a perspective view of previous embodiments of the present invention.

FIG. 3 is a perspective view of previous embodiments shown in FIG. 2 but without the wheels.

FIG. 4A is a profile view of the frame of the vehicle in previous embodiments.

FIG. 4B is a bottom view of the frame of the vehicle. In previous embodiments

FIG. 5 is a perspective view of the inside of the rack and pinion box in previous embodiments.

FIG. 6 is a block diagram of the components of the embodiments of the invention.

FIG. 7 is a block diagram that is provided as an example of the scalability of the first embodiment of the present invention.

FIG. 8 is a block diagram that is provided as an example of the scalability of the first embodiment of the present invention.

FIG. 9 is a block diagram that shows that the electrical energy generated by the regenerative energy system may be stored in a battery or a supercapacitor.

FIG. 10 is a diagram of the components of the first embodiment of the invention without the chassis of the vehicle.

FIG. 11 is a perspective view of a unit or cell of a first embodiment of a wave motion transformation system.

FIG. 12 is a perspective view of the wave motion capture system of the first embodiment.

FIG. 13 is a perspective view of a hydraulic portion of the hydraulic piston system of the wave motion transformation system.

FIG. 14 is a perspective view of a piston portion of the hydraulic piston system, a hydraulic to linear motion conversion system, a gear reduction and amplification system, and a generator.

FIG. 15 is a perspective view of a plurality of wave motion transformation systems that are placed in a single building and all operating together to generate electricity.

FIG. 16 is a close-up perspective view showing a first embodiment of a layout of a series of wave motion transformation systems operating together.

FIG. 17 is a close-up perspective view showing the first embodiment of a layout of a series of wave motion transformation systems operating together.

FIG. 18 a perspective view showing the present invention disposed on train tracks that is operating to generate electricity from the passage of train cars on the train tracks.

FIG. 19 is a close-up perspective view of a hydraulic actuator and a spring.

FIG. 20 is a perspective view of a piston portion of the hydraulic piston system, a hydraulic to linear motion conversion system, a gear reduction amplification system, and a generator.

FIG. 21 is a block diagram showing that electric energy can be stored in a battery, a supercapacitor, or transferred directly to a power grid.

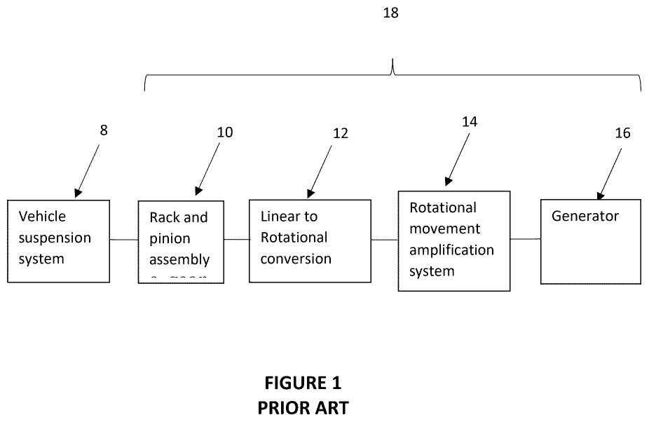

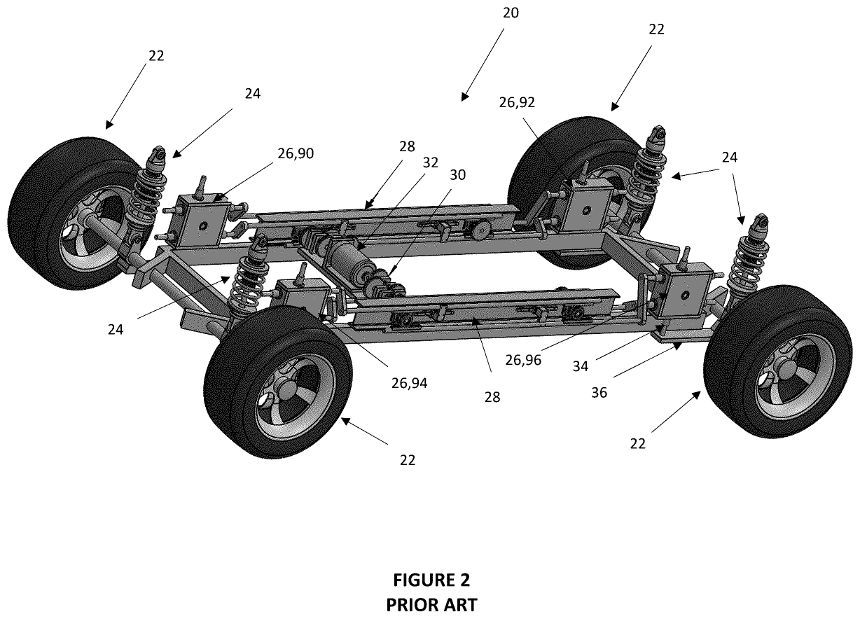

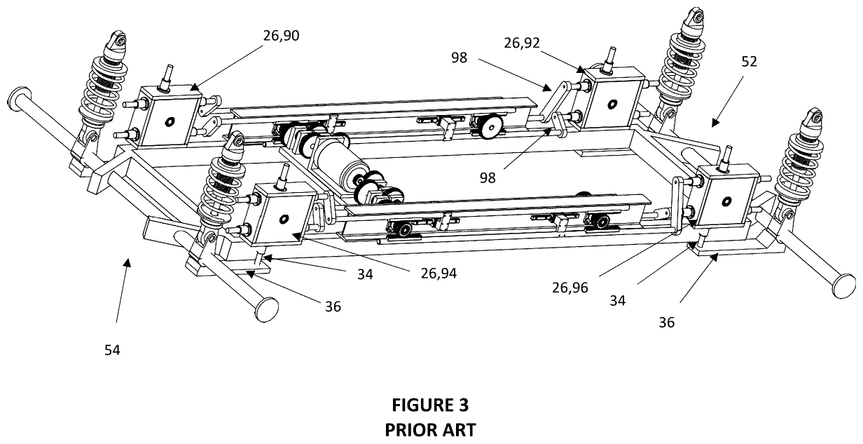

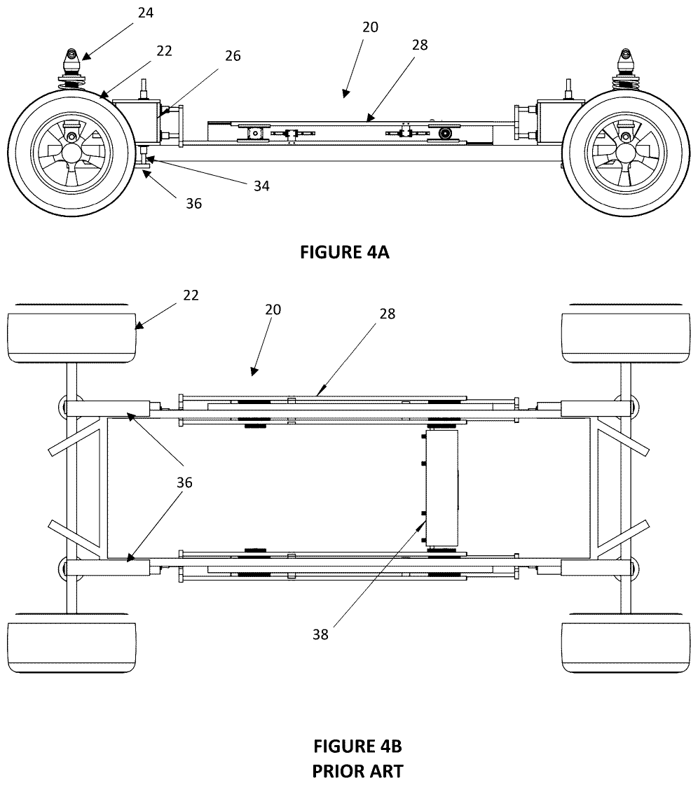

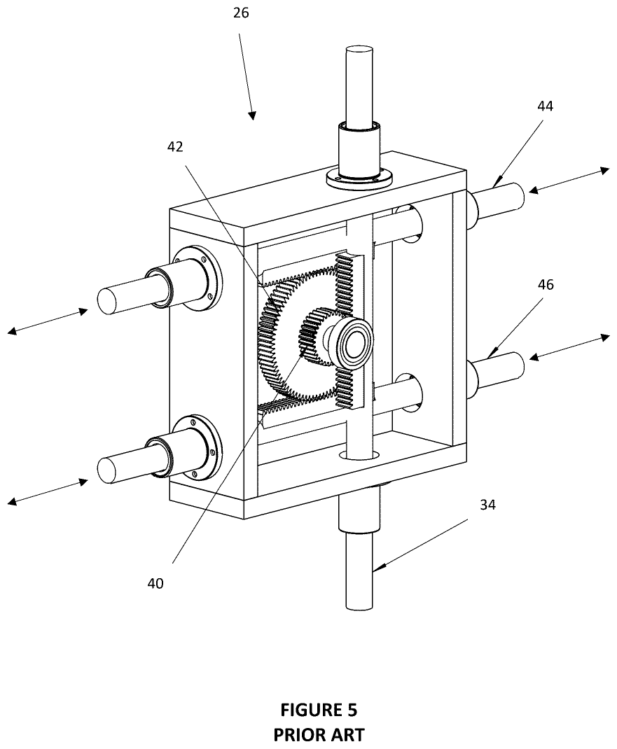

### DETAILED DESCRIPTION

Reference will now be made to the drawings in which the various embodiments of the present invention will be discussed so as to enable one skilled in the art to make and use the invention. It is to be understood that the following description illustrates embodiments of the present invention and should not be viewed as narrowing the claims which follow.

The present invention has previously been used as part of a vehicle. In that situation, the up-and-down movements of a vehicle as it travels on a road may be translated into linear movements and then into rotational movements to thereby power a generator. The generator produces electricity for immediate use by the vehicle or stores the electricity in a battery or supercapacitor.

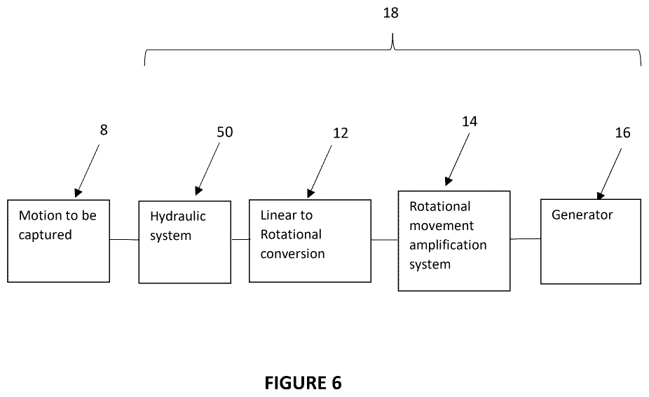

FIG. 6 is a block diagram of the components of a first embodiment of the present invention. As will be explained, the first embodiment is able to capture the kinetic energy from both the upward and the downward motion of wave motion or the vehicle suspension system 8.

In the block diagram view in FIG. 6, a hydraulic system 50 may be coupled to the vehicle suspension system 8. The hydraulic system 10 is then coupled to a linear motion to rotational movement conversion system 12 which is in turn coupled to a rotational movement amplification system 14. The rotational movement amplification system 14 is then coupled to an alternator or generator 16 for generating electricity. The combination of the hydraulic system 10, the linear to rotational movement conversion system 12, the rotational movement amplification system 14, and the alternator 16 may be referred to as the regenerative energy system 18.

The hydraulic system 10 is utilized to convert up-and-down linear motion to horizontal linear motion, and then horizontal linear motion is converted to rotational motion using the linear to rotational movement conversion system 12. The rotational movement amplification system 14 is then utilized to amplify the rotational motion to thereby generate electricity using the generator 16. While the first embodiment shows that the conversion of linear motion to rotational motion and then the amplification of the rotational motion is performed by separate components, it should be understood that these functions may also be combined in a single step or device. However, the first embodiment uses the hydraulic system 10 to transfer linear motion to a location in the vehicle where it can be converted to rotational motion and finally coupled to a generator 16 to thereby generate electricity. The electricity is then either stored in a battery or capacitor or delivered directly to an electrical motor.

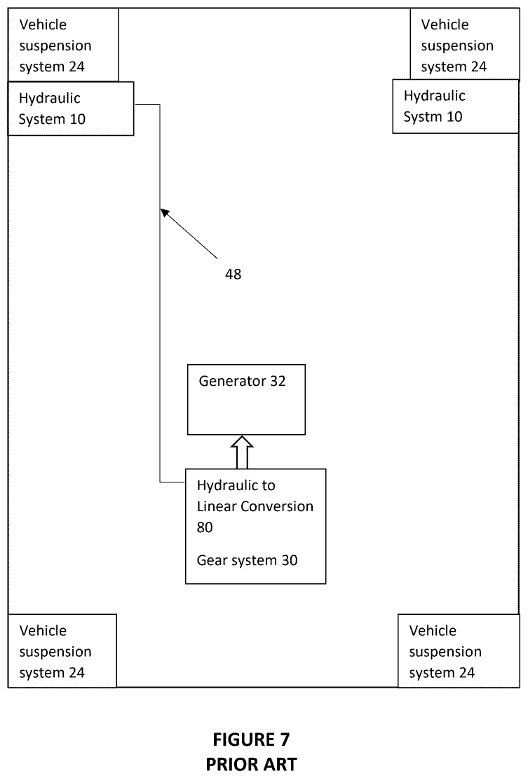

FIG. 7 is a block diagram that is provided as an example of the scalability of the present invention. Thus, in a first embodiment, a hydraulic system 10 may be disposed adjacent to a vehicle suspension system 24, followed by a hydraulic hose 48 to a hydraulic to linear conversion system 80 and gear system 30, and finally to a generator 32.

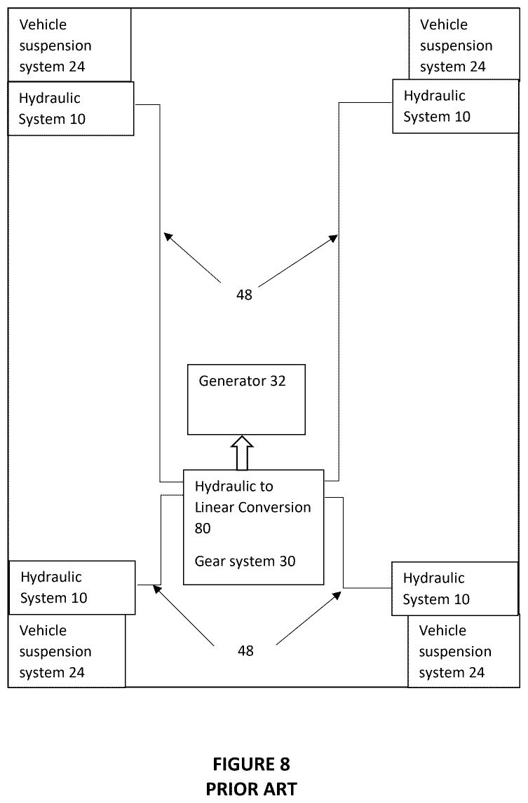

Similarly, the embodiment shown in FIG. 7 may be modified to include more components to achieve the desired electrical output of the regeneration energy system 18. For example, the hydraulic system 10 may be disposed adjacent to each vehicle suspension system 24, followed by the hydraulic hose 48 to the hydraulic to linear conversion system 80 and gear system 30, and finally to the generator 32 as shown in FIG. 8.

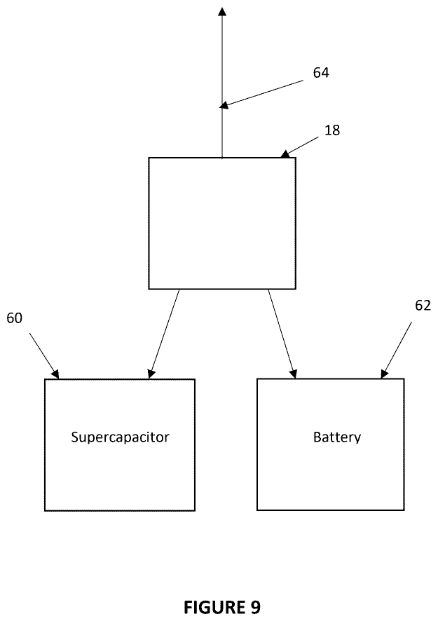

FIG. 9 is used to illustrate that in another aspect of the embodiments of the invention, a specific utilization of the electrical energy that is being generated by the embodiments of the invention may be shown. Specifically, it is another aspect of the invention that the electrical energy generated by the regenerative energy system 18 may be stored in a supercapacitor 60 instead of in a battery 62. Alternatively, the electrical energy may be directed only to the battery 62. In another alternative embodiment, the electrical energy may be directed to both the supercapacitor 60 and the battery 62. Finally, the energy may also be directed to a power transmission line 64 that directs energy away from the system to an electrical power grid.

Another aspect of the embodiments of the invention that should be understood regarding the generator 32 of the regenerative energy system 18. While a stock alternator may be used, the generator 32 may also be a customized part that generates a greater amount of voltage than standard vehicle generators. Furthermore, the generator 32 may be replaced with an alternator, a stepper motor, or a brushless motor, or any other suitable electrical device or motor. What is important is that the function of the generator 32 be provided in the regenerative energy system 18.

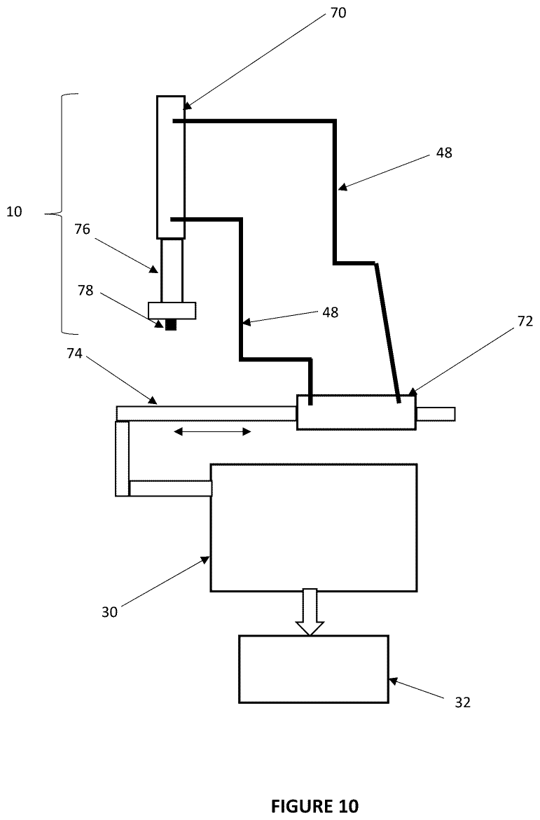

FIG. 10 is a view of components of the first embodiment of the invention that are changed from the prior art. The rack and pinion gear box and linear transformation rack of the prior art are now replaced with more robust hydraulic components.

Specifically, a hydraulic fluid cylinder 70 is shown. Hydraulic fluid cylinder is moved by wave motion or motion of a train over train tracks. There are two hydraulic hoses 48 attached to the hydraulic fluid cylinder 70 at a first end and a second end. A spring or coil 76 may be wrapped around a shaft 78 that goes into the hydraulic fluid cylinder 70. As the shaft 78 travels up and down or in and out of the hydraulic fluid cylinder 70, the hydraulic fluid flows through the hydraulic hoses 48.

The two hydraulic hoses 48 are attached to a receiving hydraulic conversion cylinder 72. As hydraulic fluid inside the hydraulic fluid cylinder 70 moves in and out when the suspension system 24 is operating, the hydraulic fluid is moving in and out of the receiving hydraulic conversion cylinder 72. Hydraulic fluid movement causes a lever arm 74 to move back and forth within the receiving hydraulic conversion cylinder 72.

The lever arm 74 is thus moving in and out of the gear box 30 in a linear motion. This linear motion is converted into rotational motion within the gear box 30 in a manner that is known to those skilled in the art. The gear box 30 functions not only to convert linear to rotational motion but also functions as a gear reduction system that is attached to the generator 32 and thereby generating electricity.

The gear box 30 may include a plurality of lever arms 74 that are coupled to other receiving hydraulic conversion cylinders 72 which are in turn coupled to other hydraulic fluid cylinders 70.

It is noted that a force may be applied to the lever arm 74 when the hydraulic fluid is flowing in one direction. When the hydraulic fluid flows in the opposite direction, no force is applied to the lever arm 74 and it is free to return to an initial position that is ready to apply force to the gear box 30. This ability to apply a force to the lever arm 74 when hydraulic fluid is flowing in only one direction may be made possible through the use of a one-way bearing. The one-way bearing may be disposed within the hydraulic conversion cylinder 72.

It should be understood that all of the suspension systems 24 are operating independently of each other. Therefore, hydraulic fluid may be flowing back and forth between the hydraulic fluid cylinders 70 and the receiving hydraulic conversion cylinders 72 at different times. This means that the lever arms 74 will be moving back and forth in and out of the gear box 30 at different times. None of that independent motion will interfere with the operation of any other lever arm 74.

The motions of the lever arms 74 may be relatively small but even one hydraulic fluid cylinder 70 may cause its corresponding lever arm 74 to move, which causes the corresponding reduction gears in the gear box 30 to rotate which causes a shaft in the generator 34 to spin which thereby generates electricity.

When the hydraulic fluid in all of the hydraulic fluid cylinders 70 are in slight motion, then this enables the gear box 30 to have many sources of linear motion being translated to rotational motion and thereby contribute to rotating the shaft of the generator 34.

The hydraulic system described in FIG. 10 may be disposed within a system that uses movement to drive the hydraulic cylinder 70. This application addresses two possible sources of movement that can be used to generate electricity. The sources of movement are wave motion and movement of a train car on train tracks.

Beginning with wave motion, capturing energy from wave motion, also known as wave energy, provides numerous advantages over existing energy sources, making it a valuable renewable energy source.

For example, wave energy is essentially a renewable and infinite source of sustainable energy. Wave energy is a renewable energy resource that is continuously replenished by natural processes. Unlike fossil fuels, which are finite, wave energy offers an inexhaustible supply, ensuring long-term energy security.

Wave energy is also clean energy. The generation of electricity from waves will produce negligible greenhouse gas emissions. This helps in mitigating climate change by reducing our reliance on carbon-intensive energy sources.

Wave energy also has high energy density. Waves carry a significant amount of energy due to their high density. This means that wave energy converters (WECs) may generate substantial power from relatively small installations compared to wind or solar farms.

Wave energy is also a consistent power supply. Waves are more predictable and consistent than other renewable energy sources. This consistency ensures a stable and reliable supply of energy, which is crucial for maintaining a balanced power grid.

Wave energy may also have a low environmental impact because of a minimal land footprint. Wave energy installations are typically located offshore, which reduces the need for land. This minimizes the impact on terrestrial ecosystems and preserves valuable land resources for other uses.

Properly designed wave energy devices may also coexist with marine life. Some structures may even serve as artificial reefs, enhancing local biodiversity by providing habitats for marine organisms.

Wave energy may also provide significant economic advantages. For example, the wave energy sector may stimulate job creation in various fields, including research and development, manufacturing, installation, and maintenance. This can boost local economies, particularly in coastal regions.

Countries with extensive coastlines may also reduce their dependence on imported fossil fuels by tapping into their wave energy potential. This enhances national energy security and reduces vulnerability to global energy market fluctuations.

The pursuit of wave energy technology drives innovation in engineering, materials science, and environmental science. Advancements in these areas can spill over into other sectors, fostering overall technological progress.

Wave energy may also complement other renewable energy sources like wind and solar. By providing a more constant energy supply, it helps to stabilize the power grid and reduce the need for energy storage solutions.

Certain wave energy devices can attenuate wave energy, reducing the impact of strong waves on shorelines and thus providing enhanced erosion mitigation. This can help protect coastal areas from erosion and extreme weather events, offering an added layer of resilience.

Wave energy installations may even act as barriers against storm surges, providing additional protection to coastal communities during extreme weather events, which are becoming more frequent due to climate change.

Once installed, wave energy devices typically have low operational and maintenance costs. Their durability and longevity contribute to their economic viability, making them a cost-effective energy solution over time.

The development of wave energy infrastructure may also present significant investment opportunities. Governments and private investors can benefit from the long-term returns associated with sustainable energy projects.

By decreasing reliance on fossil fuels, wave energy helps reduce air pollution. Cleaner air contributes to better public health outcomes and reduces healthcare costs associated with pollution-related illnesses.

Unlike conventional power plants, wave energy systems do not require water for cooling. This conserves freshwater resources, which are increasingly scarce in many parts of the world.

Incorporating wave energy into the energy mix of any country diversifies the sources of power generation. This reduces the risk associated with dependence on a single energy source and enhances overall energy resilience.

Wave energy may also be harnessed locally, reducing the need for long-distance transmission lines. This minimizes energy losses during transmission and enhances the efficiency of the energy supply chain.

Investing in wave energy aligns with the principles of sustainable development. It meets present energy needs without compromising the ability of future generations to meet their own needs, promoting environmental stewardship.

By contributing to the global renewable energy portfolio, wave energy will help combat climate change on an international scale. The widespread adoption of wave energy can significantly reduce global carbon emissions and promote a sustainable energy future. Thus, capturing energy from wave motion offers a multitude of benefits, including sustainability, high energy potential, minimal environmental impact, economic advantages, technological innovation, and enhanced coastal protection. These benefits make wave energy a promising and essential component of the global transition to renewable energy sources.

It is first useful to understand the source of kinetic energy of the embodiments of the invention. The source of kinetic energy is motion that is typically in an upward and downward direction that is constantly repeating. The motion may not be of a consistent magnitude, but it is likely to be a continuous series of wave motions that are dependent upon various environmental conditions such as wind, tides, temperature, etc.

While the embodiments of the invention are focused on capturing energy from the motion of waves on the surface of water, it should be understood that the principles apply to capturing energy from any source of repetitive motion. There is also no limit on the type of motion that may be converted and is therefore not limited to an up-and-down motion.

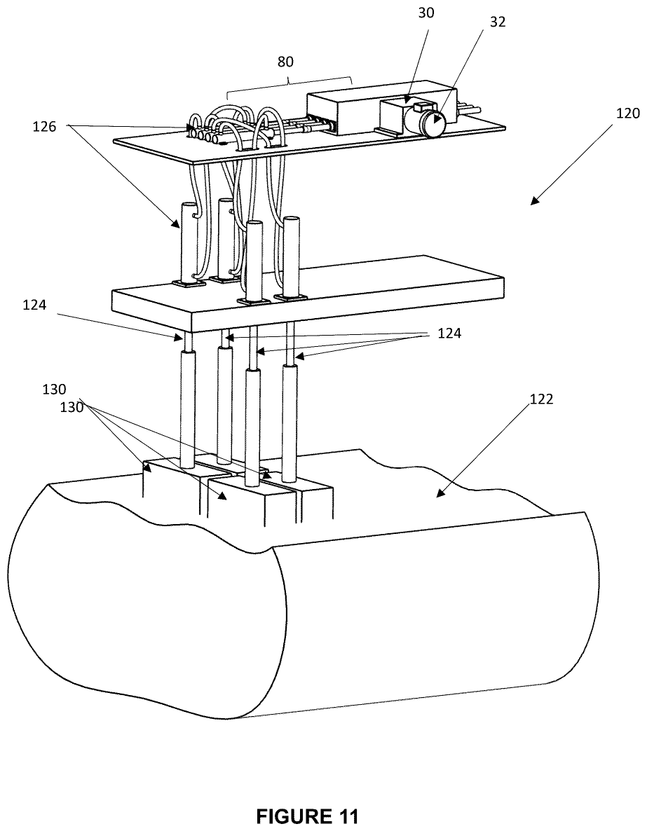

FIG. 11 is a perspective view of a single wave power cell 120. While this wave power cell 120 has certain properties, the single wave power cell 120 could just as easily have different properties. Thus, the single wave power cell 120 illustrated in FIG. 11 is only an example of how a wave power cell may be organized in order to illustrate the properties of a first embodiment of a wave power cell.

The wave power cell 120 in FIG. 11 includes a plurality of floating blocks 130. In this wave power cell 120, there are four floating blocks 130 that are disposed in the water 122. The floating blocks 120 are suspended in the water 122 and allowed to move a shaft 124 linearly in a vertical direction. Thus, as waves pass by the floating blocks 130, the shaft 124 coupled to the floating blocks moves up and down in a vertical manner.

In the first embodiment, the shaft 124 is coupled to a hydraulic system 126, a hydraulic to linear conversion system 80, a gear reduction system 30 and a single generator 32.

Similarly, the embodiment shown in FIG. 11 may be modified to include more components to achieve the desired electrical output of the wave motion transformation system 18.

It is noted that while the first embodiment includes the hydraulic system 126 that converts wave motion to hydraulic action, then utilizes the hydraulic to linear conversion system 80 to convert hydraulic action to linear motion, then uses the gear reduction system 30 to convert linear motion to rotational motion which then drives the generator 32, it may be possible for the hydraulic system 126 to convert vertical motion directly to rotational motion. It is only because of the need to transfer the motion of the hydraulic system 126 to a location that is further away so that there is more room for the gear reduction system 30 and the alternator 32 that makes the hydraulic to linear conversion system 80 a necessary part of the design. However, it may be possible to eliminate the need for the hydraulic to linear conversion system 80 if the gear reduction system 30 may be disposed adjacent to the hydraulic system 126. Accordingly, in an alternative embodiment, the hydraulic system 126 may direct convert vertical motion to rotational motion which is then directly coupled to the gear reduction system.

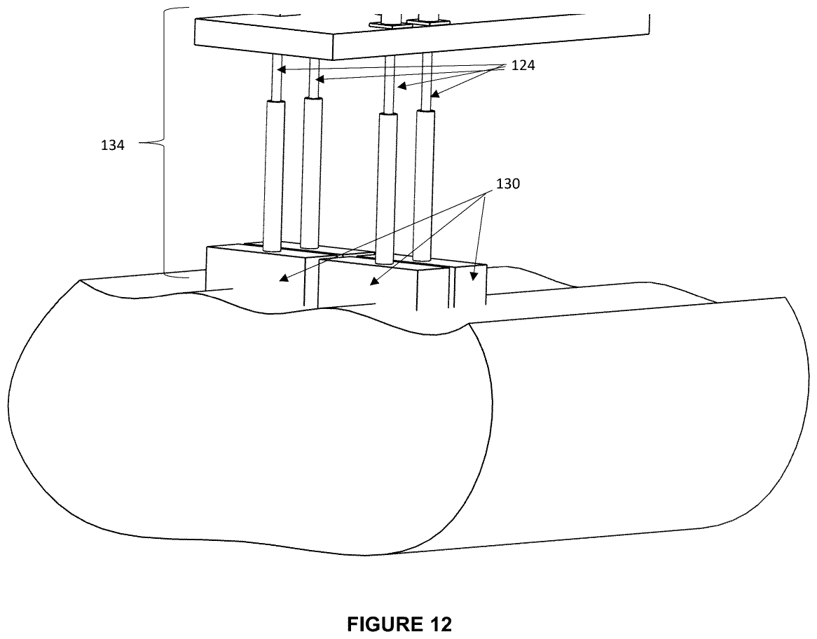

FIG. 12 is a close-up perspective view of a wave motion capture system 134 of the first embodiment.

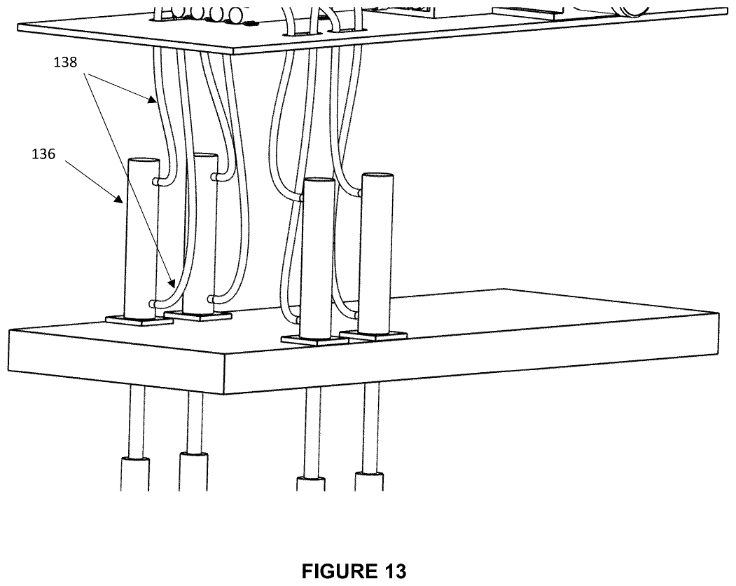

FIG. 13 is a close-up perspective view of the hydraulic portion of the hydraulic system 126 of the wave motion transformation system 18. The hydraulic system 126 includes a hydraulic fluid reservoir 136 that includes two hydraulic hoses 138 connected to it at the top and the bottom of the hydraulic fluid reservoir.

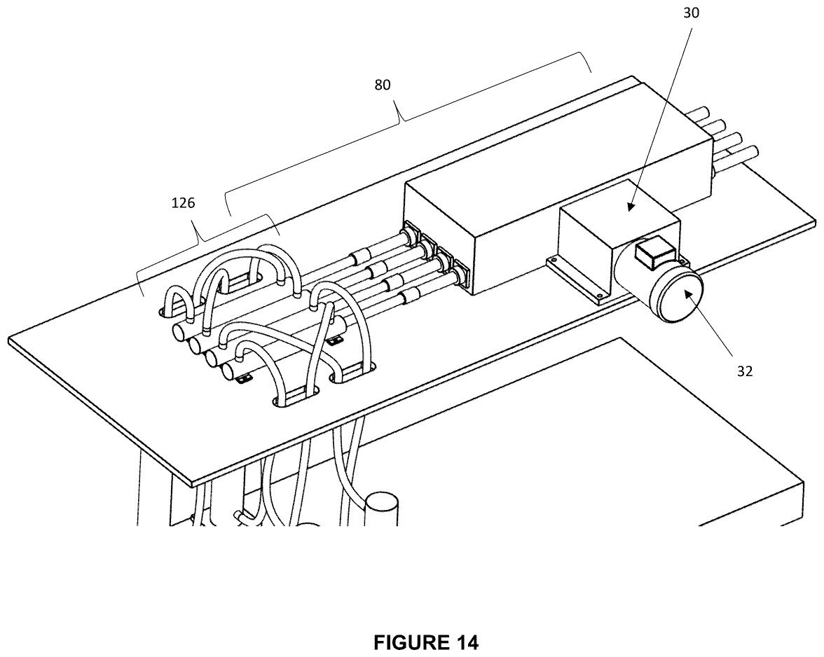

FIG. 14 is a perspective view of a piston portion of the hydraulic system 126, a hydraulic to linear conversion system 80, a gear reduction system 30 and a generator 32.

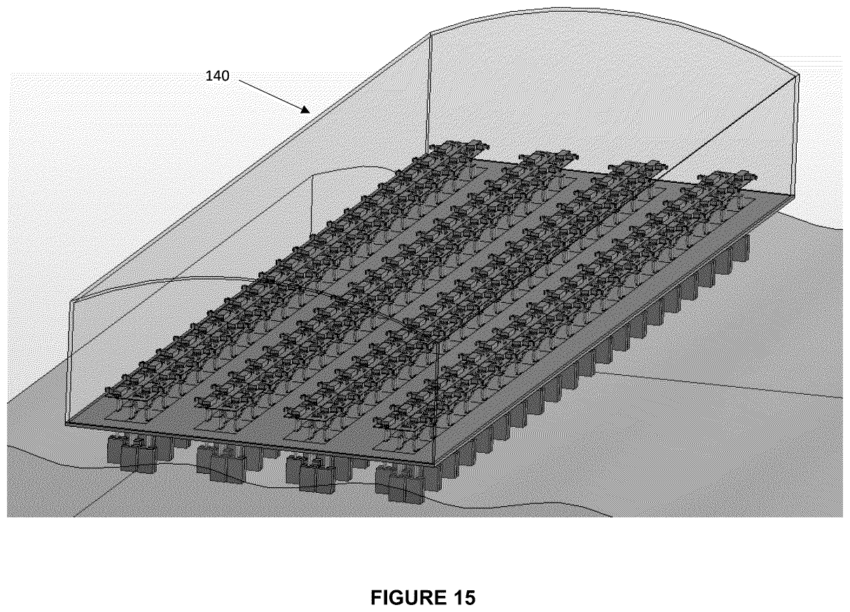

FIG. 15 shows a hydraulic hose hub 140 that houses a plurality of hydraulic systems 126, hydraulic to linear conversion systems 80, gear reduction systems 30 and generators 32.

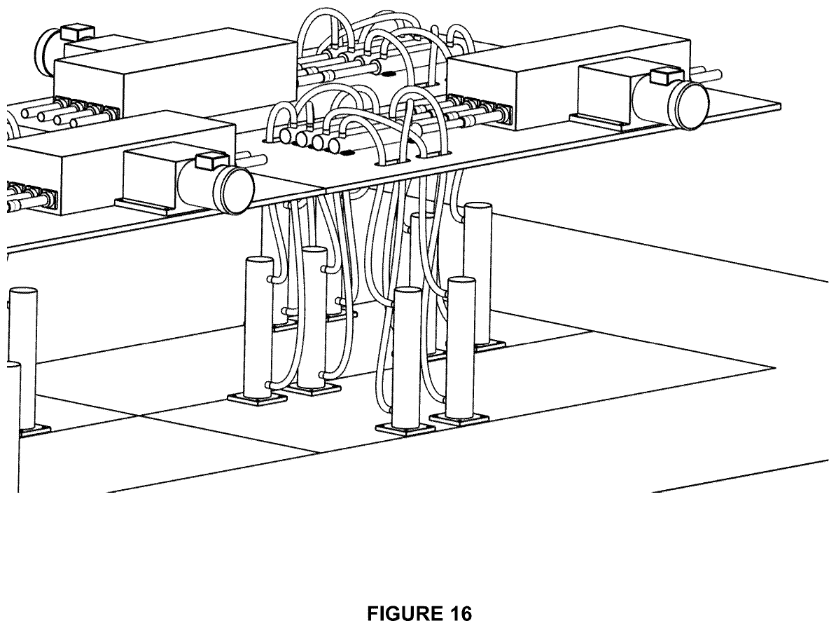

FIG. 16 shows a close-up view of the inside of just a portion of the hydraulic hose hub 140.

It should be understood that all of the hydraulic systems 126 being in independent motion are nevertheless almost always in motion because waves are constantly passing by the system. The motions may be small but even one hydraulic system 126 can cause some amount of linear motion to be translated into rotational motion which is transferred to the reduction gears in the gear reduction box 30 which causes the shaft in the generator 32 to spin which thereby generates electricity.

When the hydraulic systems 126 are in even slight motion, then this enables the gear reduction box 30 to have many sources of linear motion being translated to rotational motion and thereby contributing to rotate the shaft of the generator 32.

Experimentation has shown that, on average, several kilowatts may be generated from even shallow wave action. If this wave motion is magnified by larger waves, the number of kilowatts being generated may be substantial, and certainly enough to charge a battery or supercapacitor.

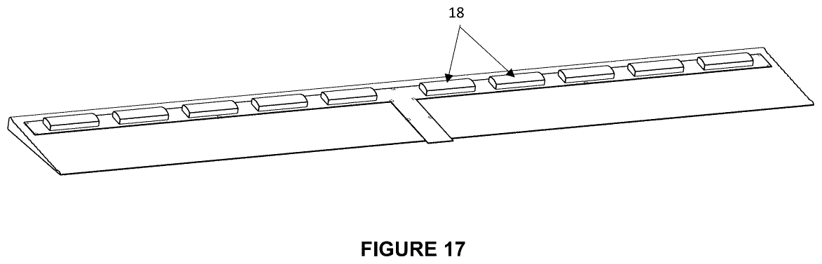

FIG. 17 is a perspective view showing a first embodiment of a layout of a series of wave motion transformation systems 18 operating together.

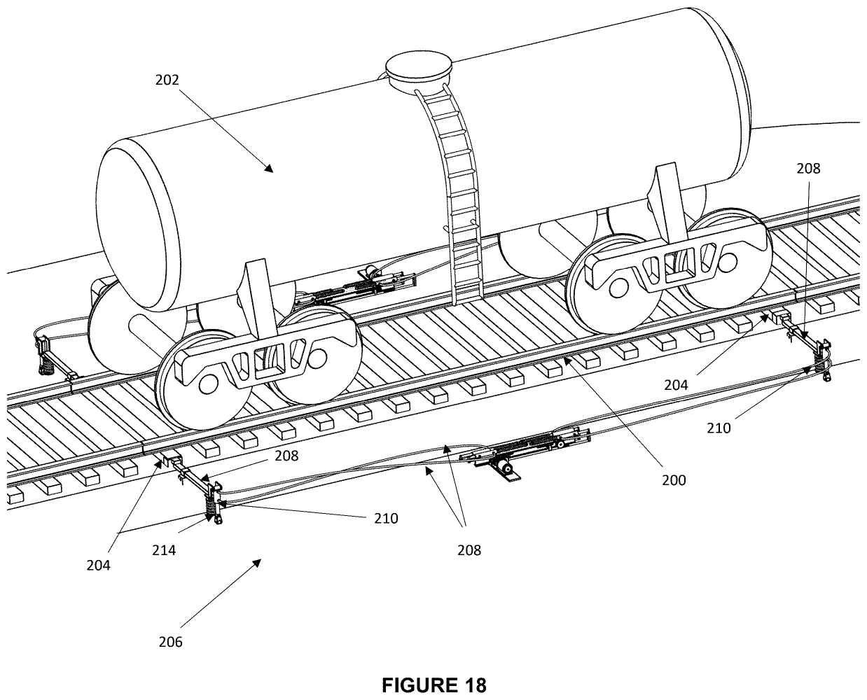

FIG. 18 a perspective view showing the train track movement transformation system 206 disposed on train tracks 200 that generates electricity from the passage of train cars 202 on the train tracks. What is first observed is that the train track movement transformation system 206 is stationary and not carried by the train cars. The train track movement transformation system 206 captures kinetic energy of train cars 202 that are rolling on the train tracks 200. The train track movement transformation system 206 uses the same components as the wave motion transformation system 18 with the exception being that instead of the movement of waves powering a hydraulic system, the movement of train track spars 204 is the source of kinetic energy.

FIG. 18 shows that there are four locations in which motion of the train tracks 200 is being captured. Specifically, the motion of the train track spars 204 will cause the motion of a lever arm 208. The lever arm 208 is coupled to a hydraulic reservoir 210 having a hydraulic hose 212 coupled at a top end of the hydraulic reservoir, and at a bottom end. Movement of the lever arm 208 causes vertical motion of hydraulic reservoir 210 on a shaft 214. The movement of the hydraulic reservoir 210 thus causes the flow of a hydraulic fluid in the hydraulic hose 212. The hydraulic fluid in the hose 212 moves to a hydraulic to linear conversion system 218. The train track movement transformation system 206 operates in the same manner as the wave motion transformation system 18.

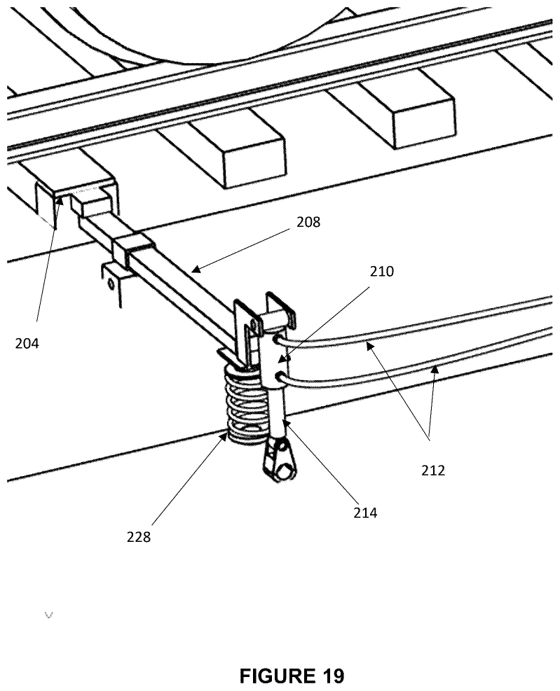

FIG. 19 is a close-up perspective view of the train track spar 204, the lever arm 208, the hydraulic reservoir 210, a spring 228, the shaft 214, and the hydraulic hoses 212.

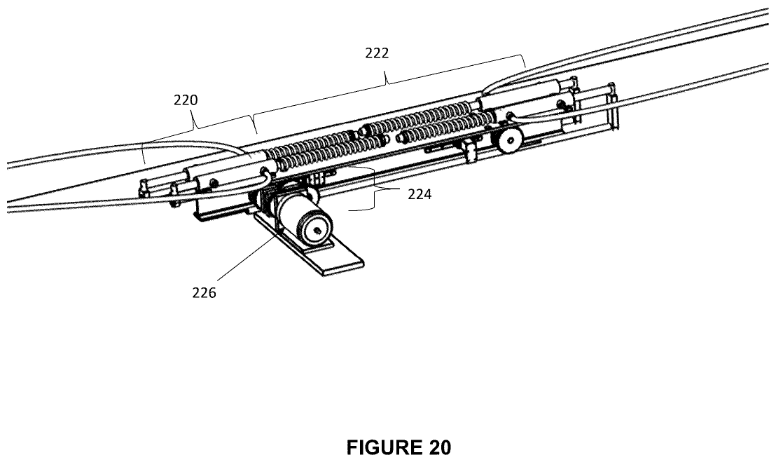

FIG. 20 is a perspective view of a hydraulic system 220, a hydraulic to linear conversion system 222, a gear reduction system 224 and a generator 226 also generate electricity.

The train track movement transformation system 206 absorbs the energy from the movement of the train track spar 204 which is transferred to the lever arm 208. The lever arm 208 in turn causes movement of the hydraulic reservoir 210 on the shaft 214. The spring 228 may be used to return the train track spar 204 to the proper position after passage of the train car 202 on the train tracks 200.

It is understood that the hydraulic reservoir 210, the shaft 214 and the spring 226 all operate to absorb the kinetic energy of the train track spar 204. Thus, these components function similar to a shock absorber in a vehicle. The shock absorber controls unwanted spring motion through a dampening process. Shock absorbers slow down and reduce the magnitude of vibratory motions by turning the kinetic energy of suspension movement into heat energy that can be dissipated through hydraulic fluid.

The train track movement transformation system 206 of the present invention generates useful energy from the up-and-down motion of the train track spar as it moves up and down at each end as the train cars pass over.

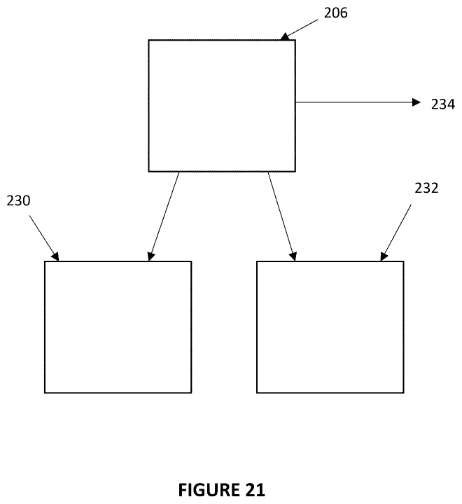

FIG. 21 is used to illustrate that in another aspect of the embodiments of the invention, a specific utilization of the electrical energy that is being generated by the embodiments of the invention may be shown. Specifically, it is another aspect of the invention that the electrical energy generated by the train track movement transformation system 206 may be stored in a supercapacitor 230 instead of in a battery 232. Alternatively, the electrical energy may be directed only to the battery 232. In another alternative embodiment, the electrical energy may be directed to both the supercapacitor 230 and the battery 232. Still alternatively, the electrical energy may be directed to a power grid 234.

Another aspect of the embodiments of the invention should be understood regarding the generator 32, 126 of the wave motion transformation system 18 and the train track movement transformation system 206. While a stock alternator may be used, the generator 32 may also be a customized part that generates a greater amount of voltage than standard vehicle generators. Furthermore, the generator 32, 126 may be replaced with an alternator, a stepper motor, or a brushless motor. What is important is that the function of the generator 32, 226 be provided in the energy systems 18, 206.

While the embodiments of the invention above are directed to the wave motion transformation system 18 and the train track movement transformation system 106, it should be understood that there are other sources of movement that may be utilized to generate electricity using a similar regenerative energy system.

In summary, in one embodiment, the invention is a wave motion transformation system is configured to capture energy from waves that pass by the system, said system comprising a wave motion capture system comprised of floating boxes that move up and down relative to the waves passing by, a hydraulic system that is coupled to the wave motion capture system, wherein the a hydraulic system that is coupled to the wave motion capture system, wherein the hydraulic system converts motion of the wave motion capture system to movement of a hydraulic fluid, a hydraulic to linear conversion system coupled to the hydraulic system, wherein the hydraulic to linear conversion system converts the motion of the hydraulic fluid into linear motion, a gear reduction system coupled to the hydraulic to linear conversion system, wherein the gear reduction system receives the linear motion and converts it to rotational motion and amplifies the rotational motion, and a single shaft generator coupled to the gear reduction system, wherein the generator receives the amplified rotational motion and generates electricity therefrom.

Similarly, a method for generating electricity from the passing of waves by the wave motion transformation system is a method comprising the steps of 1) providing a wave motion capture system that captures movements of the waves, 2) providing a hydraulic system that is coupled to the wave motion capture system, 3) converting the vertical motion of the wave motion capture system to movement of hydraulic fluid using the hydraulic system, 4) providing a hydraulic to linear conversion system coupled to the hydraulic system, 5) converting the motion of the hydraulic fluid to linear motion, 6) providing a gear reduction system coupled to the linear conversion system to convert the linear motion to rotational motion, 7) amplifying the rotational motion receiving from the linear conversion system using the gear reduction system, 8) providing a single shaft generator coupled to the gear reduction system, and 8) generating electricity from the alternator as the gear reduction system rotates the generator.

In another embodiment, the invention is a train track movement transformation system that is configured to capture energy from train cars that pass over movable train track spars, said system comprising a train track motion capture system comprised of train track spars that move up and down relative to the train cars that are passing by, a hydraulic system that is coupled to the train track movement capture system, wherein the hydraulic system converts vertical motion of the train track movement capture system to horizontal motion, a linear transformation system coupled to the hydraulic system, wherein the linear transformation system converts the horizontal motion of the hydraulic system to rotational motion, a gear reduction system coupled to the linear transformation system, wherein the gear reduction system receives the rotational motion of the linear transformation system and amplifies the rotational motion, and a single shaft generator coupled to the gear reduction system, wherein the generator receives the amplified rotational motion and generates electricity therefrom.

Similarly, a method for generating electricity from train cars that pass over movable train track spars is a method comprising the steps of 1) providing a train track movement capture system that captures movements of the train track spars, 2) providing a hydraulic system that is coupled to the train track movement capture system, 3) converting the vertical motion of the train track movement capture system to horizontal motion using the hydraulic system, 4) providing a linear transformation system coupled to the hydraulic system, 5) converting the horizontal motion of the hydraulic system to rotational motion using the linear transformation system, 6) providing a gear reduction system coupled to the linear transformation system, 7) amplifying the rotational motion receiving from the linear transformation system using the gear reduction system, 8) providing a single shaft alternator coupled to the gear reduction system, and 8) generating electricity from the alternator as the gear reduction system rotates the alternator.

It should be understood that the train track movement transformation system 106 might capture movement other than the movement of the train track spar 104.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. It is the express intention of the applicant not to invoke 35 U.S.C. § 112, paragraph 6 for any limitations of any of the claims herein, except for those in which the claim expressly uses the words ‘means for’ together with an associated function.

What is claimed is:

1. A wave motion transformation system configured to capture energy from waves in the form of a wave power cell, said system comprising:
a wave motion capture system that is moved by waves;
a hydraulic system that is coupled to the wave motion capture system, wherein the hydraulic system converts motion of the wave motion capture system to movement of a hydraulic fluid;
a hydraulic to linear conversion system coupled to the hydraulic system, wherein the hydraulic to linear conversion system converts the motion of the hydraulic fluid into linear motion;
a gear reduction system coupled to the hydraulic to linear conversion system, wherein the gear reduction system receives the linear motion and converts it to rotational motion and amplifies the rotational motion; and
a generator coupled to the gear reduction system, wherein the generator receives the amplified rotational motion and generates electricity therefrom.

2. The wave motion transformation system as defined in claim 1 wherein the system is further comprised of a battery that is charged by the generator.

3. The wave motion transformation system as defined in claim 1 wherein the system is further comprised of a supercapacitor that is charged by the generator.

4. The wave motion transformation system as defined in claim 1 wherein the system is further comprised of a connection to a power grid.

5. The wave motion transformation system as defined in claim 1 wherein the system is further comprised of a plurality of wave power cells.

6. A method for generating electricity from the passing of waves by the wave motion transformation system is a method comprising the steps of:
providing a wave motion capture system that captures movements of the waves;
providing a hydraulic system that is coupled to the wave motion capture system;
converting the vertical motion of the wave motion capture system to movement of hydraulic fluid using the hydraulic system;
providing a hydraulic to linear conversion system coupled to the hydraulic system and converting the motion of the hydraulic fluid to linear motion;
providing a gear reduction system coupled to the linear conversion system to convert the linear motion to rotational motion;
amplifying the rotational motion receiving from the linear conversion system using the gear reduction system;
providing a single shaft generator coupled to the gear reduction system; and
generating electricity from the alternator as the gear reduction system rotates the generator.
